(19) United States
(12) Patent Application Publication
(10) Pub. No.: US 2023/0043021 A1
(43) Pub. Date: Feb. 9, 2023

(54) TIMING COMPENSATION DEVICE FOR OPTICAL OUTPUT SIGNAL OF LIDAR AND METHOD THEREOF

(71) Applicant: HL KLEMOVE CORP., Incheon (KR)

(72) Inventors: Yun Ki HAN, Gyeonggi-do (KR); HoSeok Shin, Gyeonggi-do (KR); HakGu Han, Gyeonggi-do (KR); Chulseung Lee, Gyeonggi-do (KR); Yong Min Park, Gyeonggi-do (KR); Hyuk Ryu, Seoul (KR)

(21) Appl. No.: 17/882,468

(22) Filed: Aug. 5, 2022

(30) Foreign Application Priority Data
Aug. 6, 2021 (KR) 10-2021-0103687

(51) Int. Cl. G01S 7/481; G01D 5/14; G01S 7/484

(52) U.S. Cl. CPC G01S 7/4817; G01D 5/145; G01S 7/484

(57) ABSTRACT

The present invention relates to a timing compensation device for an optical output signal of a Lidar and a method thereof, including an encoder for detecting a rotation period of a motor provided in a scanner, a Lidar controller for detecting a jitter time from the rotation period of the motor detected by the encoder, creating a histogram including a mode of a jitter time, and performing optical output control at a time point of the rotation period of the motor or when the mode of the jitter time is compensated for the rotation period of the motor; and a light transmitter for outputting laser light to the scanner according to the optical output control of the Lidar controller.

### CROSS-REFERENCE TO RELATED APPLICATION

This application claims priority to and the benefit of Korean Patent Application No. 10-2021-0103687, filed on Aug. 6, 2021, the disclosure of which is incorporated herein by reference in its entirety.

### TECHNICAL FIELD

The present invention relates to a timing compensation device for an optical output signal of a Lidar and a method thereof, and more specifically to a timing compensation device for an optical output signal and a method thereof, which are capable of preventing errors caused by external shock or vibration.

### BACKGROUND ART

Recently, the technology of autonomous vehicles has been actively developed, and a Lidar is applied to determine a distance from an object required for autonomous driving and to determine the type of an object.

Although a scanning-type scanner and a scintillation-type scanner are generally known according to the scanning method, the scanning-type scanner having high position accuracy is mainly used.

The scanning-type scanner uses a method of measuring a distance from a sensor to a surrounding object by measuring a time until the laser light of a Lidar is reflected on an object and then returns to the Lidar sensor.

FIG. 1 is a block diagram of a general Lidar.

Referring to FIG. 1, the conventional Lidar is configured by including a light transmitter 200 for outputting laser light, a scanner 300 for outputting light by controlling the path of the laser light of the light transmitter 200, a light receiver 500 for receiving the reflected light of the laser light through the scanner 300, and a Lidar controller 100 for controlling the light transmitter 200 such that the laser light is emitted at a specific timing and outputting a control signal according to the optical output timing of the light transmitter 200 to calculate the distance from an object by detecting a time between optical output and optical input.

In the drawing, the window 400 is a cover glass for the protection of a Lidar.

The scanner 300 may include a motor and a mirror rotated by the motor. That is, the scanner 300 may control the optical path by using the rotating mirror.

The resolution is determined according to the frequency of light output during one cycle (one rotation) of the Lidar, and the frequency of light output must ensure proper uniformity, and precise timing control is required.

However, the conventional scanner 300 may not be able to maintain a constant rotation speed due to external shock or vibration. Jitter may occur in the motor due to external shock or vibration, or due to a design error of the circuit.

As such, when the rotation of the motor or mirror of the scanner 300 cannot maintain a constant speed, an angle error occurs in the Lidar system that requires precise angular resolution, and there has been a problem in that it is impossible to detect an object at an accurate location and measure a distance.

### DISCLOSURE

### Technical Problem

The technical problems to be solved by the present invention provide a timing compensation device for an optical output signal of a Lidar and a method thereof, which are capable of monitoring jitter and controlling an optical output timing suitable therefor.

### Technical Solution

The timing compensation device for an optical output signal of a Lidar according to an aspect of the present invention for solving the aforementioned problems includes an encoder for detecting a rotation period of a motor provided in a scanner; a Lidar controller for detecting a jitter time from the rotation period of the motor detected by the encoder, creating a histogram including a mode of a jitter time, and performing optical output control based on the detected jitter time and the histogram; and a light transmitter for outputting laser light to the scanner according to the optical output control of the Lidar controller.

In an exemplary embodiment of the present invention, the encoder may include a first Hall sensor and a second Hall sensor, and wherein the Lidar controller may receive signals of the first Hall sensor and the second Hall sensor and detects the rotation period and jitter time of the motor.

In an exemplary embodiment of the present invention, the Lidar controller may include a first timer for storing a clock synchronized with edges of signals of the first Hall sensor and the second Hall sensor, and a second timer for storing the clock with a mode or an ideal mode of jitter time.

In an exemplary embodiment of the present invention, the Lidar controller may perform optical output control in synchronization with the clock of the first timer when the jitter time detected from the signals of the first Hall sensor and the second Hall sensor is within a jitter tolerance range.

In an exemplary embodiment of the present invention, the Lidar controller may set a jitter time to the jitter tolerance range when the accumulated number of jitter times is greater than or equal to a predefined value.

In an exemplary embodiment of the present invention, the Lidar controller may identify whether the mode of the jitter time is out of a mode tolerance range when the jitter time detected in the signals of the first Hall sensor and the second Hall sensor is out of the jitter tolerance range, perform optical output control in synchronization with the clock of the second timer for storing the clock synchronized with edges of signals of the first Hall sensor and the second Hall sensor and the mode of jitter time, when the mode of the jitter time is within the mode tolerance range, and perform optical output control in synchronization with the clock of the second timer for storing the clock synchronized with edges of signals of the first Hall sensor and the second Hall sensor and the ideal mode of jitter time, when the mode of the jitter time is out of a mode tolerance range.

In an exemplary embodiment of the present invention, the Lidar controller may create the histogram, when the number of pulses of the first timer is greater than or equal to a set value.

In addition, the method for compensating for timing for an optical output signal of a Lidar according to another aspect of the present invention includes the steps of a) setting a jitter tolerance range and a mode tolerance range in a controller; b) detecting a jitter time from a rotation period of a motor provided in a scanner detected by an encoder; c) creating a histogram including a jitter time mode within the rotation period of the motor; and d) performing optical output control based on the jitter time detected in step b) and the histogram created in step c).

In an exemplary embodiment of the present invention, step b) may include detecting the rotation period of the motor and the jitter time by receiving signals from the first Hall sensor and the second Hall sensor included in the encoder.

In an exemplary embodiment of the present invention, the method may further include the steps of storing a clock synchronized with edges of signals of the first Hall sensor and the second Hall sensor in a first timer; and storing the clock with a mode or an ideal mode of jitter time in a second timer.

In an exemplary embodiment of the present invention, the jitter time mode may be a jitter time within the highest frequency detected in the accumulated histogram by monitoring signals of the first Hall sensor and the second Hall sensor included in the encoder by the controller.

In an exemplary embodiment of the present invention, the jitter time mode may be a jitter time set in the controller.

In an exemplary embodiment of the present invention, step d) may include performing optical output control in synchronization with the clock of the first timer, when the jitter time detected from signals of the first Hall sensor and the second Hall sensor is within the jitter tolerance range.

In an exemplary embodiment of the present invention, step a) may include setting a jitter time to the jitter tolerance range when the accumulated number of jitter times is greater than or equal to a predefined value.

In an exemplary embodiment of the present invention, step d) may include the steps of identifying whether the mode of the jitter time is out of a mode tolerance range when the detected jitter time is out of the jitter tolerance range; performing optical output control at a time point when clocks synchronized with edges of signals of the first Hall sensor and the second Hall sensor are compensated with the mode of jitter time, when the mode of the jitter time is within the mode tolerance range; and performing optical output control at a time point when clocks synchronized with edges of signals of the first Hall sensor and the second Hall sensor are compensated with the ideal mode of jitter time, when the jitter time mode is out of a mode tolerance range.

### Advantageous Effects

The present invention has the effect of improving the accuracy of the resolution of a Lidar by monitoring the occurrence of jitter in real time and outputting an optical output signal at a timing that matches the motor position when the occurrence of jitter is within a tolerance range.

In addition, the present invention has the effect of improving the reliability of a Lidar system by performing timing control even in an abnormal state by compensating for a mode within the jitter tolerance range, when the occurrence of jitter exceeds the tolerance range.

### DESCRIPTION OF DRAWINGS

FIG. 1 is a block diagram of the conventional Lidar system.

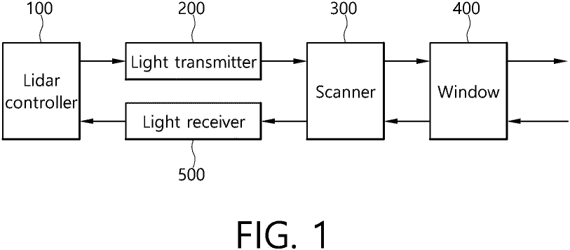

FIG. 2 is a block diagram of the timing compensation device for an optical output signal of a Lidar according to the present invention.

FIG. 3 is a waveform diagram of a Hall sensor in the absence of jitter.

FIG. 4 is a waveform diagram of a Hall sensor in which jitter is generated.

FIG. 5 is a flowchart of the method for compensating for timing for an optical output signal according to a preferred exemplary embodiment of the present invention.

FIG. 6 is an exemplary diagram of a histogram including a jitter time mode used in the present invention.

FIG. 7 is a waveform diagram of signal processing according to the present invention.

### MODES OF THE INVENTION

Hereinafter, the timing compensation device for an optical output signal of a Lidar and a method thereof according to the present invention will be described in detail with reference to the accompanying drawings.

The exemplary embodiments of the present invention are provided to more fully describe the present invention to those of ordinary skill in the art, the following exemplary embodiments may be modified into various other forms, and the scope of the present invention is not limited to the following exemplary embodiments. Rather, these exemplary embodiments are provided so that the present invention will be more thorough and complete, and will fully convey the concept of the present invention to those of ordinary skill in the art.

The terminology used herein is for the purpose of describing particular exemplary embodiments only and is not intended to limit the present invention. As used herein, the singular forms may include plural forms unless the context clearly indicates otherwise. In addition, when used in the present specification, the terms “comprise” and/or “comprising” specify the presence of the stated shapes, numbers, steps, operations, members, elements and/or groups thereof and do not preclude the presence or addition of one or more other shapes, numbers, operations, members, elements and/or groups thereof. As used herein, the term “and/or” may include any and all combinations of one or more of the associated listed items.

In the present specification, terms such as “first” and “second” are used herein merely to describe a variety of members, parts, areas, layers and/or portions, but the constituent elements are not limited by the terms. It is obvious that the members, parts, areas, layers and/or portions are not limited by the terms. The terms are used only for the purpose of distinguishing one constituent element from another constituent element. Thus, without departing from the right scope of the present invention, a first member, part, area, layer or portion may refer to a second member, part, area, layer or portion.

Hereinafter, the exemplary embodiments of the present invention will be described with reference to the drawings schematically illustrating the exemplary embodiments of the present invention. In the drawings, variations of the illustrated shape may be expected, for example, depending on manufacturing technology and/or tolerances. Therefore, the exemplary embodiments of the present invention should not be construed as limited to the specific shape of the region illustrated in the present specification, but should include, for example, changes in shape caused by manufacturing.

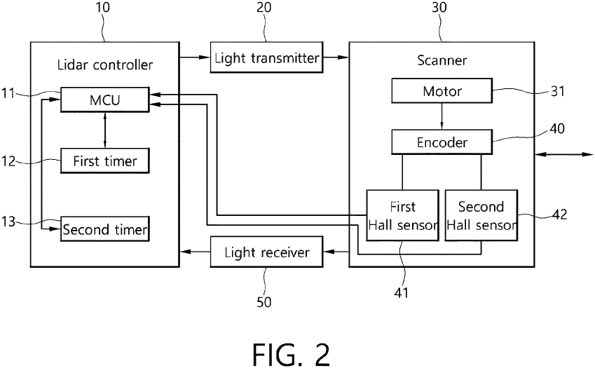

FIG. 2 is a block diagram of the timing compensation device for an optical output signal of a Lidar according to a preferred exemplary embodiment of the present invention.

Referring to FIG. 2, the present invention is a Lidar system including a Lidar controller 10, a light transmitter 20, a scanner 30 and a light receiver 50, which is configured by including a first Hall sensor 41 and a second Hall sensor 42 of an encoder 40 for detecting the rotation period of a motor 21 of the scanner 30, a controller 11 for receiving the detection signals of the first Hall sensor 41 and the second Hall sensor 42 to generate a histogram and detect the degree of jitter, a first timer 12 for detecting output times of the first Hall sensor 41 and the second Hall sensor 42 of the encoder 40 and a second timer 13 for measuring the mode time from the detection start time of the first Hall sensor 41 and the second Hall sensor 42.

Hereinafter, the configurations and operations of the timing compensation device for an optical output signal of a Lidar according to a preferred exemplary embodiment of the present invention configured as described above will be described in more detail.

First, the controller 11 is a control device provided in the Lidar controller 10, and performs control according to a given program. Although the drawing shows an MCU as an example of the controller 11, a field programmable gate array (FPGA) may be used.

The Lidar controller 10 performs the operation control of a laser generating device of the light transmitter 20, and after laser is generated by the light transmitter 20, the time until the reflected light is received through the light receiver 50 is used to calculate the distance to a target to be detected.

The first timer 12 is called a monitoring timer according to the edge waveform generated from the signals of the first Hall sensor 41 and the second Hall sensor 42, and the second timer 13 is also called compensation timer that follows signals compensated according to the occurrence of jitter time.

The scanner 30 is provided with a motor 31, and the motor 31 rotates, for example, a mirror provided in the scanner 30 to change the optical path of the laser light oscillated by the light transmitter 20.

The rotation state of the motor 31 is detected by the encoder 40. The encoder 40 includes at least two Hall sensors, and the first Hall sensor 41 and the second Hall sensor 42 are included in the present invention.

The output of the first Hall sensor 41 and the output of the second Hall sensor 42 are input to the controller 11, and the controller 11 continuously monitors the outputs of the first Hall sensor 41 and the second Hall sensor 42.

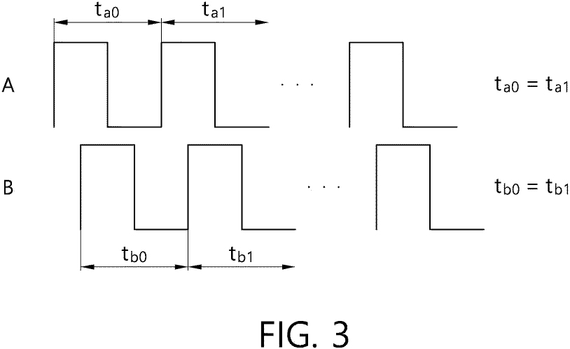

FIG. 3 shows the outputs of the ideal first Hall sensor 41 and second Hall sensor 42 without jitter generation.

In FIG. 3, A denotes the output of a first Hall sensor 41, and B denotes the output of a second Hall sensor 42.

When there is no occurrence of jitter, it can be confirmed that the rotation period of the motor 31 detected by the first Hall sensor 41 and the second Hall sensor 42 is constant.

However, jitter is generated when the motor 31 is driven due to various environmental factors, and the occurrence of jitter is a factor causing an angular error in a Lidar system requiring precise angular resolution.

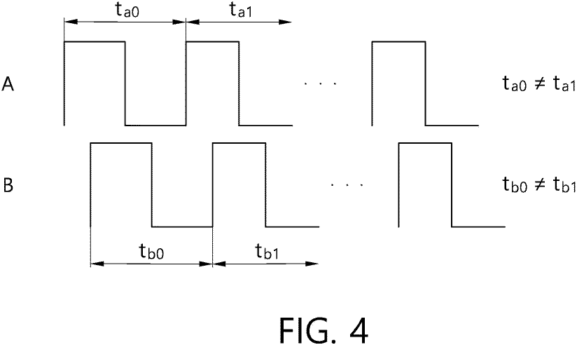

FIG. 4 shows the outputs of a first Hall sensor 41 and a second Hall sensor 42 when jitter occurs.

The controller 11 may detect jitter by monitoring the signal (A) of the first Hall sensor 41 and the signal (B) of the second Hall sensor 42.

In this case, the controller 11 may set a tolerance range of jitter. The jitter is expressed as a delay time or pulling time per one rotation period of the motor 31, and the controller 11 sets a tolerance value for the degree of a delay or pulling time in advance.

In this state, the controller 11 receives the signals (A, B) output from the first Hall sensor 41 and the second Hall sensor 42, and performs optical output control in accordance with the change in the rotation period of the motor 31. Herein, optical output control refers to controlling the timing at which light is emitted by controlling the laser generating device of the light transmitter 20 described above.

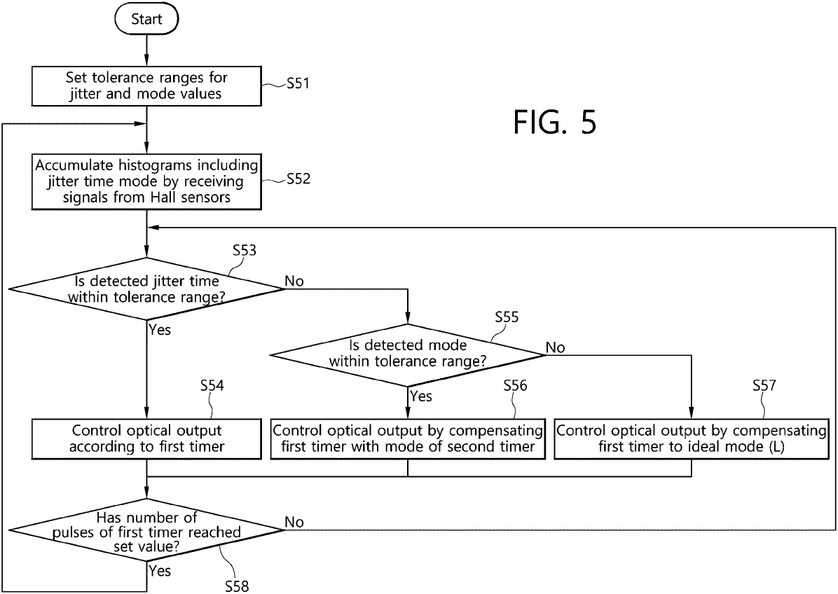

FIG. 5 is a flowchart of the method for compensating for timing for an optical output signal of a Lidar according to a preferred exemplary embodiment of the present invention.

Referring to FIG. 5, the method for compensating for timing for an optical output signal according to the present invention includes a step of setting a jitter tolerance range and a mode tolerance range in the controller 11 (S51).

According to an exemplary embodiment of the present invention, it is preferable that the jitter tolerance range is set when the accumulated number of specific jitter times is greater than or equal to a predefined value (K).

According to an exemplary embodiment of the present invention, the mode tolerance range means a predetermined section (L±M) centered on an ideal mode (L). In this case, the ideal mode (L) means a design time interval that may be obtained when the magnets of the encoder are ideally arranged.

According to an exemplary embodiment of the present invention, the predefined value (K) for defining the jitter tolerance range or the boundary value (M) for defining the mode tolerance range are not limited to any one, and the controller 11 may set it automatically according to the histogram accumulation or through receiving a user input.

Next, the method includes a step of receiving the signals of the first Hall sensor 41 and the second Hall sensor 42 and accumulating a histogram including a mode of jitter time (S52).

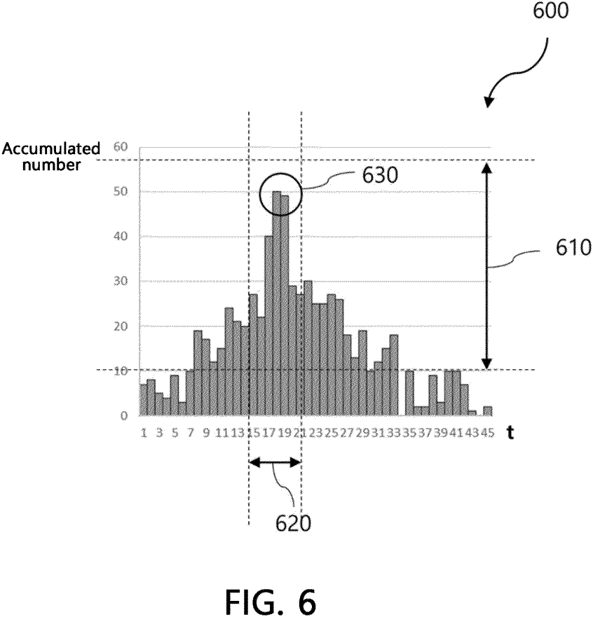

The histogram may be regenerated at regular intervals, and in order to increase the reliability of the histogram, the histogram is generated when the number of pulses counted during one rotation of the motor is greater than or equal to a predetermined value for a certain period of time, for example, one rotation of the motor. An example of the accumulated histogram is shown in FIG. 6.

Next, the method includes a step of checking whether the jitter time detected while performing signal monitoring of the first Hall sensor 41 and the second Hall sensor 42 is within the set jitter tolerance range (S53).

If it is determined in step S53 that the jitter is within the tolerance range (Yes in S53), it proceeds to a step of performing optical output control in synchronization with a clock based on the edges of the first Hall sensor 41 and the second Hall sensor 42 (S54). That is, the controller 11 performs optical output control according to the first timer 12.

If it is determined in step S53 that the jitter is out of the tolerance range (No in S53), it proceeds to a step of checking whether the detected mode is within the mode tolerance range (S55).

If it is within the mode tolerance range (Yes in S55) as a result of the determination in step S55, it proceeds to a step of performing optical output control according to a time point when the clock based on the edges of the first Hall sensor 41 and the second Hall sensor 42 is compensated with the mode (S56). That is, the controller 11 performs optical output control by compensating the first timer 12 with the mode of the second timer 13.

If it is out of the mode tolerance range (No in S55) as a result of the determination in step S55, it proceeds to a step of performing optical output control according to a time point when the clock based on the edges of the first Hall sensor 41 and the second Hall sensor 42 is compensated with the ideal mode (L) (S57). That is, the controller 11 compensates the first timer 12 with the ideal mode (L) to perform optical output control.

After the optical output control is performed according to the steps S54, S56 and S57, it proceeds to a step of identifying whether the number of pulses of the first timer has reached a set value (S58).

As described above in step S52, the histogram may be regenerated at regular intervals, and in order to increase the reliability of the histogram, the histogram is generated when the number of pulses is greater than or equal to a predetermined value, wherein the number of pulses is counted during a certain time, for example, during one rotation of the motor.

More specifically, when the Lidar continues to shake due to the vibration shock, the number of data accumulated for a certain period of time may vary. Accordingly, the controller 11 determines whether to accumulate as a histogram based on the number of count pulses exceeding a set value for a predetermined time.

If the set value is reached as a result of the determination in step S58 (Yes in S58), it returns to step S52 to update the histogram.

If the set value is not reached as a result of the determination in step S58 (No in S58), the optical output control is continued with the current histogram.

Therefore, according to the present invention, it is possible to prevent the horizontal resolution from being lowered by external shock or vibration, and to perform optical output control with higher reliability.

FIG. 6 is an exemplary diagram of a histogram including a jitter time mode used in the present invention.

FIG. 6 illustrates an example of a histogram 600 accumulated in step S52 of FIG. 5.

As described above in step S51 of FIG. 5, the jitter tolerance range is preferably set when the accumulated number of specific jitter times is greater than or equal to a predefined value (K). For example, referring to the histogram 600 of FIG. 6, the time range when the accumulated number of specific jitter times is 10 or more may be viewed as the jitter tolerance range 610.

According to an exemplary embodiment of the present invention, the mode tolerance range means a predetermined section (L±M) centered on the ideal mode (L).

For example, referring to the histogram 600 of FIG. 6, a mode 630 for the frequency of jitter time may be identified. In this case, it can be seen that the mode 630 on the histogram 600 is within the mode tolerance range 620.

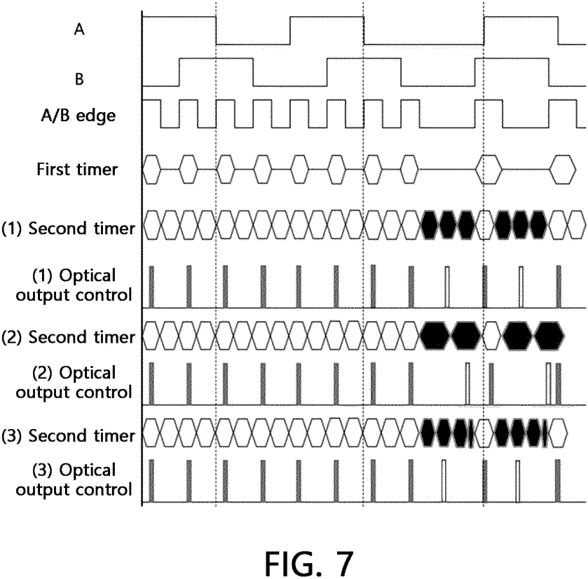

FIG. 7 is a waveform diagram of signals processed by the Lidar controller 10 including the controller 11.

Referring to FIG. 7, the controller 11 generates an edge waveform (A/B edge) of A and B when the respective signals (A, B) of the first Hall sensor 41 and the second Hall sensor 42 are input. and detects the waveform of the first timer 12 according to the generated edge waveform.

When jitter occurs in signals (A, B) of the first Hall sensor 41 and the second Hall sensor 42, it is determined whether the jitter is within the jitter tolerance range described above, and a period changed by the jitter is detected.

Jitter is a time interval error, and the controller 11 monitors the number of jitter times to find the most frequent jitter time.

The jitter time is another area not occupied by A and B in one cycle of the rotation of a normal motor 31, which is detected by the second timer 13.

That is, the space between the clock periods of the first timer 12 becomes a jitter time, and the second timer 13 becomes a clock including the jitter time.

Referring again to FIG. 7, depending on whether the detected jitter time is within the tolerance range or the detected mode is within the tolerance range, the Lidar controller 10 performs optical output control according to the clock of the first timer 12 or the clock of the compensated second timer 13.

More specifically, when jitter does not occur or the jitter time is within a jitter tolerance range, the controller 11 performs optical output control in synchronization with the clock of the first timer 12.

Hereinafter, as illustrated in FIG. 7, three compensation examples will be described.

Example (1) shows a clock signal of the second timer and optical output control according thereto when the jitter time is outside the jitter tolerance range but the mode is within the tolerance range.

In Example (1), it can be confirmed that the clock of the second timer 13 is normally compensated in the space between the clock periods of the first timer 12 such that the optical output control is properly performed at a certain period regardless of whether jitter occurs.

Examples (2) and (3) show a clock signal of the second timer 13 and optical output control according thereto when the jitter time is out of the jitter tolerance range and the mode is also out of the tolerance range.

In this case, according to step S57 of FIG. 5, the controller 11 must compensate the first timer 12 with the ideal mode (L) to control optical output.

However, when the second timer 13 is abnormally compensated as in Example (2), an error occurs in that the periodicity is disturbed during the optical output control according to the second timer 13. On the other hand, when the second timer 13 is compensated with the ideal mode (L) as in Example (3), it can be confirmed that the optical output control is properly performed at a certain period regardless of whether jitter occurs.

Accordingly, the present invention may prevent the horizontal resolution error of a Lidar from occurring due to external shock or vibration, thereby improving reliability.

It will be apparent to those of ordinary skill in the art that the present invention is not limited to the above exemplary embodiments and may be implemented with various modifications and variations without departing from the technical gist of the present invention.

### EXPLANATION OF REFERENCE NUMERALS

10: Lidar controller 11: Controller 12: First timer 12: Second timer 20: Light transmitter 30: Scanner 31: Motor 40: Encoder 41: First Hall sensor 42: Second Hall sensor 50: Light receiver

1. A timing compensation device for an optical output signal of a Lidar, comprising:
an encoder for detecting a rotation period of a motor provided in a scanner;
a Lidar controller for detecting a jitter time from the rotation period of the motor detected by the encoder, creating a histogram including a mode of a jitter time, and performing optical output control based on the detected jitter time and the histogram; and
a light transmitter for outputting laser light to the scanner according to the optical output control of the Lidar controller.

2. The timing compensation device of claim 1, wherein the encoder comprises a first Hall sensor and a second Hall sensor, and
wherein the Lidar controller receives signals of the first Hall sensor and the second Hall sensor and detects the rotation period and jitter time of the motor.

3. The timing compensation device of claim 2, wherein the Lidar controller comprises a first timer for storing a clock synchronized with edges of signals of the first Hall sensor and the second Hall sensor, and a second timer for storing the clock with a mode or an ideal mode of jitter time.

4. The timing compensation device of claim 3, wherein the Lidar controller performs optical output control in synchronization with the clock of the first timer when the jitter time detected from the signals of the first Hall sensor and the second Hall sensor is within a jitter tolerance range.

5. The timing compensation device of claim 4, wherein the Lidar controller sets a jitter time to the jitter tolerance range when the accumulated number of jitter times is greater than or equal to a predefined value.

6. The timing compensation device of claim 4, wherein the Lidar controller identifies whether the mode of the jitter time is out of a mode tolerance range when the jitter time detected in the signals of the first Hall sensor and the second Hall sensor is out of the jitter tolerance range,
performs optical output control in synchronization with the clock of the second timer for storing the clock synchronized with edges of signals of the first Hall sensor and the second Hall sensor and the mode of jitter time, when the mode of the jitter time is within the mode tolerance range, and
performs optical output control in synchronization with the clock of the second timer for storing the clock synchronized with edges of signals of the first Hall sensor and the second Hall sensor and the ideal mode of jitter time, when the mode of the jitter time is out of a mode tolerance range.

7. The timing compensation device of claim 3, wherein the Lidar controller creates the histogram, when the number of pulses of the first timer is greater than or equal to a set value.

8. A method for compensating for timing for an optical output signal of a Lidar, comprising the steps of:
a) setting a jitter tolerance range and a mode tolerance range in a controller;
b) detecting a jitter time from a rotation period of a motor provided in a scanner detected by an encoder;
c) creating a histogram including a jitter time mode within the rotation period of the motor; and
d) performing optical output control based on the jitter time detected in step b) and the histogram created in step c).

9. The method of claim 8, wherein step b) comprises detecting the rotation period of the motor and the jitter time by receiving signals from the first Hall sensor and the second Hall sensor included in the encoder.

10. The method of claim 9, further comprising the steps of:
storing a clock synchronized with edges of signals of the first Hall sensor and the second Hall sensor in a first timer; and
storing the clock with a mode or an ideal mode of jitter time in a second timer.

11. The method of claim 8, wherein the jitter time mode is a jitter time within the highest frequency detected in the accumulated histogram by monitoring signals of the first Hall sensor and the second Hall sensor included in the encoder by the controller.

12. The method of claim 8, wherein the jitter time mode is a jitter time set in the controller.

13. The method of claim 10, wherein step d) comprises performing optical output control in synchronization with the clock of the first timer, when the jitter time detected from signals of the first Hall sensor and the second Hall sensor is within the jitter tolerance range.

14. The method of claim 13, wherein step a) comprises setting a jitter time to the jitter tolerance range when the accumulated number of jitter times is greater than or equal to a predefined value.

15. The method of claim 13, wherein step d) comprises the steps of:
identifying whether the mode of the jitter time is out of a mode tolerance range when the detected jitter time is out of the jitter tolerance range;
performing optical output control at a time point when clocks synchronized with edges of signals of the first Hall sensor and the second Hall sensor are compensated with the mode of jitter time, when the mode of the jitter time is within the mode tolerance range; and
performing optical output control at a time point when clocks synchronized with edges of signals of the first Hall sensor and the second Hall sensor are compensated with the ideal mode of jitter time, when the jitter time mode is out of a mode tolerance range.
